(19) United States
(12) Patent Application Publication
(10) Pub. No.: US 2011/0050572 A1
(43) Pub. Date: Mar. 3, 2011

(54) INPUT DEVICE MODEL TESTING SYSTEM

(75) Inventors: Chen-Ning Hsi, Taipei (TW); Wei-Yu Chen, Guangzhou (CN)

(73) Assignee: PRIMAX ELECTRONICS LTD., Taipei (TW)

(21) Appl. No.: 12/617,296

(22) Filed: Nov. 12, 2009

(30) Foreign Application Priority Data
Aug. 28, 2009 (TW) 098128964

(51) Int. Cl. G06F 3/033; G06F 3/02

(52) U.S. Cl. 345/163; 345/168; 348/143; 382/190

(57) ABSTRACT

An input device model testing system is provided for testing an input device model that is placed on a working plane. The input device model testing system includes image pickup devices for capturing the input device model and the working plane, a microphone for receiving the clicking sound of the input device model, a computer screen for displaying the working plane image, and a computer host. The computer host includes a model image analyzing program and a working plane image analyzing program. The working plane image and the model image are respectively analyzed by the model image analyzing program and the working plane image analyzing program, so that associated user input instructions are executed.

### FIELD OF THE INVENTION

The present invention relates to a testing system, and more particularly to an input device model testing system.

### BACKGROUND OF THE INVENTION

With increasing development of scientific technologies, multimedia products and computers become essential in our daily lives. In the computer systems, input devices play important roles for communicating the computer and the user. The common input devices of the computer systems include for example mice, keyboards or trackballs. Among these input devices, mice are the most prevailing because they are very easy-to-use. When a mouse is held on the palm of a user's hand, the user may move the mouse to control movement of the cursor shown on the computer screen. In addition, by operating the click buttons of the mouse, the user may select a desired item on the function menu of the browsing frame or execute a corresponding function. Moreover, via the keyboard, the user may input symbols or texts as required. In other words, the importance of the keyboard is also obvious.

As known, before an input device is mass-produced by a manufacturer, the external form of the input device needs to be designed in advance. Take a mouse for example. In designing the external form of the mouse, the manufacturer needs to fabricate a mouse model according to the anticipated external form. The mouse model has the same outward appearance as the mouse. In addition, the mouse model is made of foam or plastic material. After the mouse model is fabricated, the mouse model is placed on a desk plane, and a testing procedure is performed to test the tactile feel of the mouse model by holding and/or moving the mouse model. By gathering the opinions of the testers, the manufacturer will modify the external form of the mouse model. After undue testing procedures and modifying procedures, a desired external form of the mouse model is determined. Afterwards, a real mouse is fabricated according to the desired external form of the mouse model. The use of the mouse model is helpful to simulate the operating conditions of a real mouse and realize the possibly defects of designing the real mouse. In a case that some defects of the mouse model have been found during the testing procedure, the user could correct the defects in order to design a more perfect mouse model. Under this circumstance, the possibility of alerting the designing process of the real mouse will be minimized.

Generally, during the testing procedure is performed to test the tactile feel of the mouse model, the user should place the mouse model on a desk plane while imagining the situation of using the mouse model to control the computer. Since the mouse model is not in communication with the computer, the tester usually places his or her hand on the mouse model and moves the mouse model on the desk plane while looking at the mouse model. In other words, the action of operating the mouse model by the tester has nothing to with the computer. Furthermore, when a real mouse is operated by a user, the line of vision of the user is always directed toward the computer screen rather than the mouse. Since the tester fails to be personally on the scene to simulate the mouse model as the real mouse, so many details associated with the operations of the mouse model are ignored. Under this circumstance, the opinions of the tester have unsatisfactory reference values and fail to be totally accepted by the manufacturer.

### SUMMARY OF THE INVENTION

It is an object of the present invention to provide a testing system for testing an input device model.

In accordance with an aspect of the present invention, there is provided an input device model testing system. The input device model testing system includes a working plane, a mouse model, a first image pickup device, a second image pickup device, a first computer screen, a microphone, and a computer host. The working plane includes a plurality of simulated icons. The mouse model is placed on the working plane for pointing to one of the simulated icons. The mouse model includes a cursor element, a first button zone and a second button zone. The first image pickup device is used for capturing the working plane, thereby generating a working plane image. The working plane image includes an image of the simulated icon that is pointed by the cursor element of the mouse model. The second image pickup device is used for capturing the mouse model, thereby generating a model image. The model image includes an image of the button zone that is clicked. The first computer screen is used for displaying the working plane image. The microphone is used for receiving a clicking sound emitted from the mouse model when the mouse model is clicked, thereby generating a clicking signal. The computer host is in communication with the first image pickup device, the second image pickup device, the microphone and the first computer screen for receiving the clicking signal, the working plane image and the model image. The computer host includes a model image analyzing program for discriminating which of the button zones is clicked according to the model image, a working plane image analyzing program for discriminating which of the simulated icons is pointed by the cursor element according to the working plane image, a simulated icon link program for establishing linkages between the simulated icons and respective icon shortcuts, and a plurality of icon shortcuts corresponding to respective simulated icons. According to the clicking signal and by the model image analyzing program and the working plane image analyzing program, the computer host discriminates which of the button zones is clicked and which of the simulated icons is pointed. As a consequence, a first button function or a second function associated with the pointed simulated icon is executed, and a result of executing the first button function or the second function is displayed on the first computer screen.

In an embodiment, after the computer host discriminates which of the button zones is clicked and which of the simulated icons is pointed, the simulated icon link program executes a function of linking the pointed simulated icon with a corresponding icon shortcut.

In an embodiment, the icon shortcuts includes a “My Computer” icon shortcut, a “My Document” icon shortcut, and an “Internet Explorer” icon shortcut

In an embodiment, the first button function and the second button function are a left-button function and a right-button function, respectively.

In an embodiment, when the cursor element is pointed to the simulated icon corresponding to the “My Computer” icon shortcut and the first button zone of the mouse model is clicked, the simulated icon link program executes a function of triggering the “My Computer” icon shortcut.

In an embodiment, when the cursor element is pointed to the simulated icon corresponding to the “My Computer” icon shortcut and the second button zone of the mouse model is clicked, the simulated icon link program executes a function of showing a right-button menu.

In an embodiment, when the cursor element is pointed to the simulated icon corresponding to the “My Computer” icon shortcut and the first button zone of the mouse model is double clicked, the simulated icon link program executes a function of opening the “My Computer” icon shortcut.

In an embodiment, the working plane is a cardboard, and the simulated icons are drawn on the cardboard.

In an embodiment, the working plane is a glass platform, the input device model testing system further includes a second computer screen under the glass platform and in communication with the computer host for displaying a Windows interface of the computer host, and the icon shortcuts are shown on the Windows interface.

In an embodiment, the simulated icons shown on the glass platform correspond to the icon shortcuts shown on the Windows interface, respectively.

In an embodiment, the cursor element includes an arrow part for pointing to one of the simulated icons, and an extension part connected to a main body of the mouse model.

In an embodiment, the cursor element is made of transparent plastic material, and the arrow part of the cursor element is coated with white paint for facilitating identification.

In an embodiment, the model image analyzing program and the working plane image analyzing program respectively discriminate the clicked button zone and the pointed simulated icon according to an image recognition technology.

In accordance with another aspect of the present invention, there is provided an input device model testing system. The input device model testing system includes a keyboard model, an image pickup device, a computer screen, a microphone, and a computer host. The keyboard model includes a plurality of key zones. The image pickup device is used for capturing the keyboard model, thereby generating a model image. The model image includes an image of the key zone that is depressed. The computer screen is used for displaying an input message interface. The microphone is used for receiving a depressing sound emitted from the keyboard model when one of the key zones of the keyboard model is depressed, thereby generating a corresponding depressing signal. The computer host is in communication with the image pickup device, the microphone and the computer screen for receiving the depressing signal and the model image. The computer host includes a model image analyzing program for discriminating which of the key zones is depressed according to the model image, and the input message interface. According to the depressing signal and by the model image analyzing program, the computer host discriminates which of the key zones is depressed, so that a text or symbol corresponding to the depressed key zone is inputted to the computer host and the text or symbol is shown on the input message interface of the computer screen.

In an embodiment, the input message interface is a Microsoft Word document file or a Notepad file.

In an embodiment, the model image is divided into a plurality of image blocks by the model image analyzing program, and the image blocks correspond to respective key zones.

In an embodiment, the key zones at least comprises an A key zone, a B key zone, and a C key zone.

In an embodiment, when the A key zone, the B key zone and the C key zone are successively depressed and respective depressing signals are generated by the microphone, the image blocks of the model image corresponding to the A key zone, the B key zone and the C key zone are successively sheltered and the depressing signals are transmitted to the computer host, so that letters ABC are inputted to the input message interface and shown on the computer screen by the computer host.

In an embodiment, the model image analyzing program discriminates the depressed zone according to an image recognition technology.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic architecture diagram illustrating an input device model testing system according to a first embodiment of the present invention;

FIG. 2 is schematic diagram illustrating a model image obtained by the input device model testing system according to the first embodiment of the present invention;

FIG. 3 is schematic diagram illustrating a plurality of icon shortcuts shown on the second computer screen of the input device model testing system according to the first embodiment of the present invention;

FIG. 4 is a schematic architecture diagram illustrating an input device model testing system according to a second embodiment of the present invention;

FIG. 5 is a schematic architecture diagram illustrating an input device model testing system according to a third embodiment of the present invention;

FIG. 6 is schematic diagram illustrating a model image obtained by the input device model testing system according to the third embodiment of the present invention; and

FIG. 7 is schematic diagram illustrating an input message interface shown on the computer screen of the input device model testing system according to the third embodiment of the present invention.

### DETAILED DESCRIPTION OF THE PREFERRED EMBODIMENT

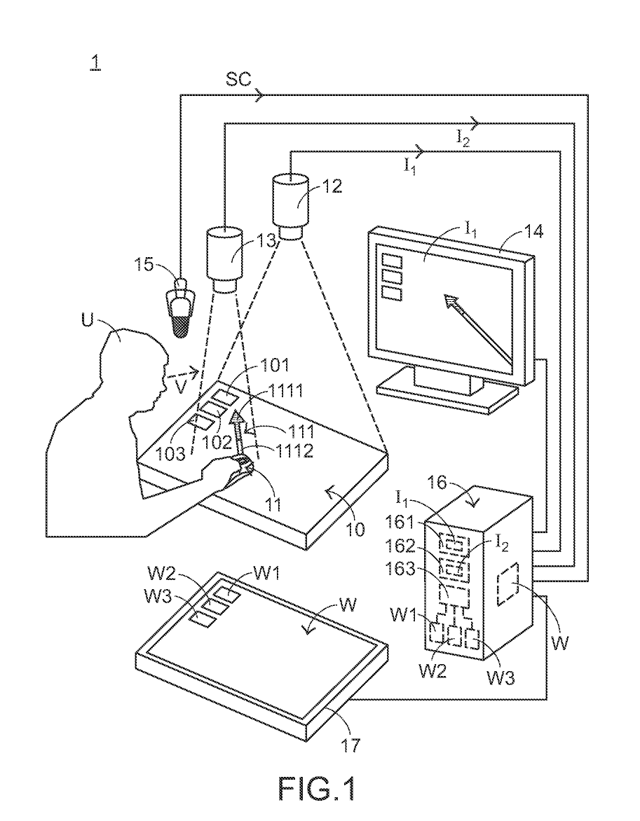

The present invention provides an input device model testing system. FIG. 1 is a schematic architecture diagram illustrating an input device model testing system according to a first embodiment of the present invention. As shown in FIG. 1, the input device model testing system 1 comprises a working plane 10, a mouse model 11 placed on the working plane 10, a first image pickup device 12, a second image pickup device 13, a microphone 15, a first computer screen 14, a second computer screen 17, and a computer host 16.

The working plane 10 has a first simulated icon 101, a second simulated icon 102, and a third simulated icon 103. In this embodiment, the working plane 10 is a glass platform. The second computer screen 17 is disposed under the glass platform 10.

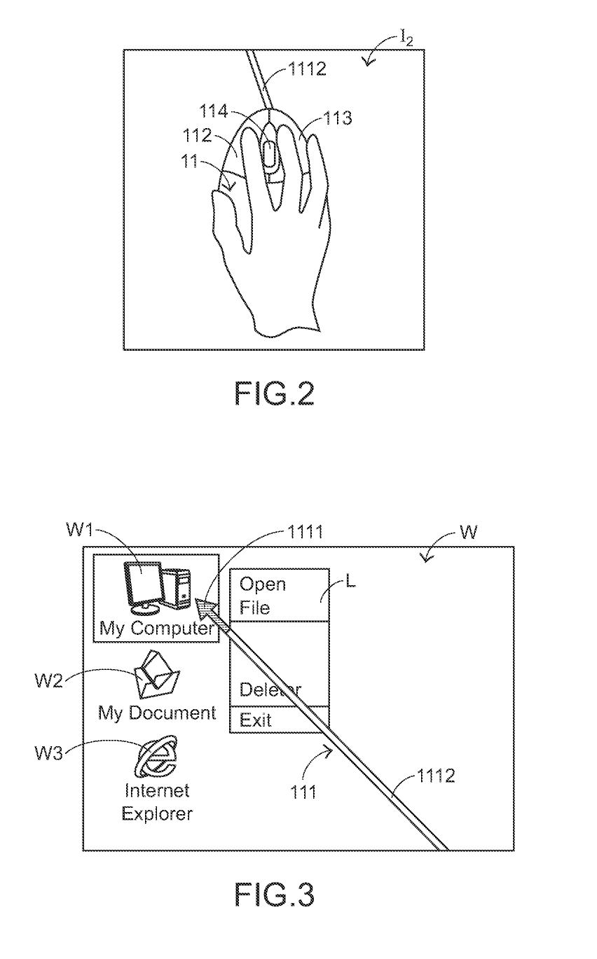

The mouse model 11 comprises a cursor element 111, a first button zone 112 (see FIG. 2) and a second button zone 113 (see FIG. 2). The cursor element 111 is arranged on the working plane 10 for pointing to one of the simulated icons 101, 102 and 103. The cursor element 111 comprises an arrow part 1111 and an extension part 1112. The arrow part 1111 points to one of the simulated icons 101, 102 and 103. The extension part 1112 is connected to the main body of the mouse model 11. In this embodiment, the cursor element 111 is made of transparent plastic material. For facilitating identification, the arrow part 1111 of the cursor element 111 is coated with white paint. That is, the arrow part 1111 with the white paint simulates the cursor on the computer screen.

The first image pickup device 12 is in communication with the computer host 16. The first image pickup device 12 is used for capturing the working plane 10, thereby generating a working plane image I1 to the computer host 16. The working plane image I1 also includes the image of the one of the simulated icons 101˜103 that is pointed by the cursor element 111 of the mouse model 11. The second image pickup device 13 is also in communication with the computer host 16. The second image pickup device 13 is used for capturing the mouse model 11, thereby generating a model image I2 to the computer host 16. The model image I2 also includes the image of the first button zone 112 or the second button zone 113 that is clicked by the user. The first computer screen 14 is in communication with the computer host 16 for displaying the working plane image I1. The microphone 15 is in communication with the computer host 16 for receiving a clicking sound emitted from the mouse model 11 when the mouse model 11 is clicked by the user. When the clicking sound is received, the microphone 15 issues a clicking signal SC to the computer host 16.

The clicking signal SC, the working plane image I1 and the model image I2 are transmitted to the computer host 16. The computer host 16 further comprises a model image analyzing program 161, a working plane image analyzing program 162, a simulated icon link program 163, a Windows interface W, a first icon shortcut W1 corresponding to the first simulated icon 101, a second icon shortcut W2 corresponding to the second simulated icon 102, and a third icon shortcut W3 corresponding to the third simulated icon 103. According to the model image I2, the model image analyzing program 161 discriminates which of the first button zone 112 and the second button zone 113 is clicked. According to the working plane image I1, the working plane image analyzing program 162 discriminates which of the simulated icons 101, 102 and 103 is pointed by the cursor element 111. In this embodiment, the model image analyzing program 161 and the working plane image analyzing program 162 respectively discriminate and analyze the clicked button zones and the pointed simulated icon according to an image recognition technology. By executing the simulated icon link program 163, the linkages between the simulated icons 101˜103 and respective icon shortcuts W1˜W2 will be established. In other words, by analyzing the working plane image I1, the working plane image analyzing program 162 will realize which of the simulated icons 101, 102 and 103 is pointed by the cursor element 111. Similarly, by analyzing the model image I2, the model image analyzing program 161 will realize which of the first button zone 112 and the second button zone 113 is clicked. According to the clicking signal SC, the computer host 16 could realize whether a clicking action is generated. After the computer host 16 realizes which button zone is clicked and which simulated icon is pointed, the simulated icon link program 163 will execute the function of linking the pointed simulated icon with a corresponding icon shortcut.

The second computer screen 17 is in communication with the computer host 16 for displaying the Windows interface W. The icon shortcuts W1, W2 and W3 are shown on the Windows interface W. Since the working plane 10 is a glass platform and the second computer screen 17 is disposed under the working plane 10, the icon shortcuts W1, W2 and W3 of the Windows interface W shown on the second computer screen 17 are viewable through the working plane 10. In other words, the simulated icons 101, 102 and 103 shown on the working plane correspond to the icon shortcuts W1, W2 and W3, respectively. In this embodiment, the first icon shortcut W1 is a “My Computer” icon shortcut, the second icon shortcut W2 is a “My Document” icon shortcut, and the third icon shortcut W3 is an “Internet Explorer” icon shortcut (see FIG. 3).

Please refer to FIG. 1 again. When the input device model testing system 1 is used by the user U to test the mouse model 11, the working plane 10 is captured by the first image pickup device 12, and the obtained working plane image I1 is transmitted to the first computer screen 14 through the computer host 16. In other words, the working plane image I1 is displayed on the first computer screen 14 to be viewed by the user U. Under this circumstance, instead of looking at the mouse model 11, the line of vision V of the user U is directed toward the first computer screen 14 during the mouse model 11 is tested by the user U. As a consequence, the input device model testing system 1 could simulate the conditions of operating a real mouse.

When the input device model testing system 1 is used by the user U to test the mouse model 11, the user U could arbitrarily move the mouse model 11 on the working plane 10 such that the arrow part 1111 of the cursor element 111 points to one of the simulated icons 101, 102 and 103. In addition, the moving trajectory of the cursor element 111 is recorded in the working plane image I1. On the other hand, during the mouse model 11 is tested by the user U, the clicking action of the mouse model 11 is captured by the second image pickup device 13 and recorded in the model image I2.

FIG. 2 is schematic diagram illustrating a model image obtained by the input device model testing system according to the first embodiment of the present invention. Please refer to FIGS. 1 and 2. In a case that the first button zone 112 of the mouse model 11 is clicked by the user U, the computer host 16 executes a first button function. Whereas, in a case that the second button zone 113 of the mouse model 11 is clicked by the user U, the computer host 16 executes a second button function. In this embodiment, the first button function and the second button function are a left-button function and a right-button function, respectively.

For example, when the mouse model 11 is moved by the user U to have the arrow part 1111 of the cursor element 111 point to the first simulated icons 101 and then the second button zone 113 of the mouse model 11 is clicked by the user U, the image of the action of clicking the second button zone 113 by the user U will be recorded in the model image I2. At the same time when the mouse model 11 is clicked by the user U, the clicking sound emitted from the mouse model 11 is recorded by the microphone 15 and the microphone 15 issues a corresponding clicking signal SC to the computer host 16. In addition, the model image I2 is also transmitted to the computer host 16. After the working plane image I1, the model image I2 and the clicking signal SC are received by the computer host 16, the working plane image analyzing program 162 discriminates that the pointed simulated icon is the first simulated icon 101 according to the working plane image I1, the model image analyzing program 161 discriminates that the second button zone 113 is clicked according to the model image I2, and the computer host 16 realizes that the clicking action occurs according to the clicking signal SC.

After the computer host 16 discriminates the pointed simulated icon and the clicked button zone, the simulated icon link program 163 executes a function of establishing the linkage between the first simulated icon 101 and the first icon shortcut W1 (e.g. the “My Computer” icon shortcut). In a case that the second button zone 113 is clicked, the simulated icon link program 163 executes a function of showing a right-button menu associated with the “My Computer” icon shortcut (see FIG. 3).

Similarly, in a case that the arrow part 1111 of the cursor element 111 points to the first simulated icons 101 corresponding to the “My Computer” icon shortcut W1 and then the first button zone 112 of the mouse model 11 is clicked, the simulated icon link program 163 will execute the function of triggering the “My Computer” icon shortcut. Whereas, in a case that the arrow part 1111 of the cursor element 111 points to the first simulated icons 101 corresponding to the “My Computer” icon shortcut W1 and then the first button zone 112 of the mouse model 11 is double clicked, the simulated icon link program 163 will execute the function of opening the “My Computer” icon shortcut.

From the above description, the input device model testing system 1 of the present invention is capable of simulating the conditions of operating a real mouse. In addition, the computer host 16 could execute instructions in response to operations of the mouse model 11 by the user U. During the testing procedure of the input device model testing system 1, the user U could be interactive with the computer host 16, so that the efficacy of being personally on the scene to simulate the mouse model as the real mouse is obtained.

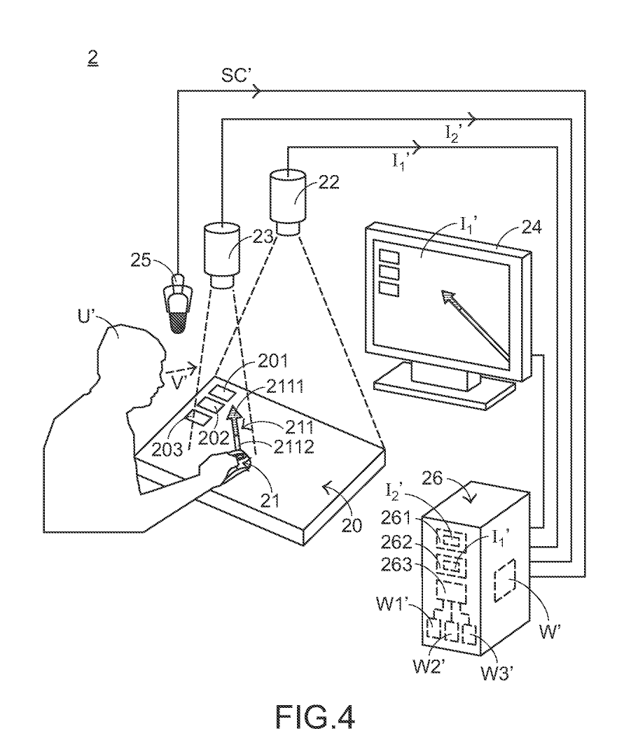

FIG. 4 is a schematic architecture diagram illustrating an input device model testing system according to a second embodiment of the present invention. As shown in FIG. 4, the input device model testing system 2 comprises a working plane 20, a mouse model 21, a first image pickup device 22, a second image pickup device 23, a microphone 25, a computer screen 24, and a computer host 26. The working plane 20 has a first simulated icon 201, a second simulated icon 202, and a third simulated icon 203. The mouse model 21 has a cursor element 211. The cursor element 211 comprises an arrow part 2111 and an extension part 2112. The first image pickup device 22 is used for capturing the working plane 20, thereby generating a working plane image I1′ to the computer host 26. The second image pickup device 23 is used for capturing the mouse model 21, thereby generating a model image I2′ to the computer host 26. The microphone 25 is used for receiving a clicking sound emitted from the mouse model 21 when the mouse model 21 is clicked by the user. When the clicking sound is received, the microphone 25 issues a clicking signal SC′ to the computer host 26. The computer host 26 further comprises a model image analyzing program 261, a working plane image analyzing program 262, a simulated icon link program 263, a Windows interface W′, a first icon shortcut W1′ corresponding to the first simulated icon 201, a second icon shortcut W2′ corresponding to the second simulated icon 202, and a third icon shortcut W3′ corresponding to the third simulated icon 203. The components of the computer host 26 are substantially identical to those of the computer host 16 of the first embodiment, and are not redundantly described herein.

The input device model testing system 2 is distinguished from the input device model testing system 2 in that the working plane 20 is a cardboard and the simulated icons 201, 202 and 203 are drawn on the cardboard. The operating principles of the input device model testing system 2 are identical to those of the computer host 16 of the first embodiment, and are not redundantly described herein. Since the input device model testing system 2 is a cardboard, the working plane 20 is relatively cost-effective to meet the requirements of different users.

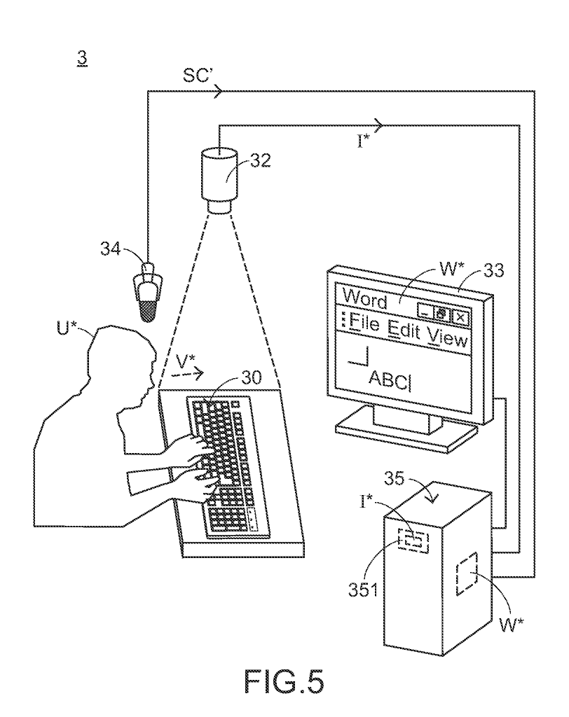

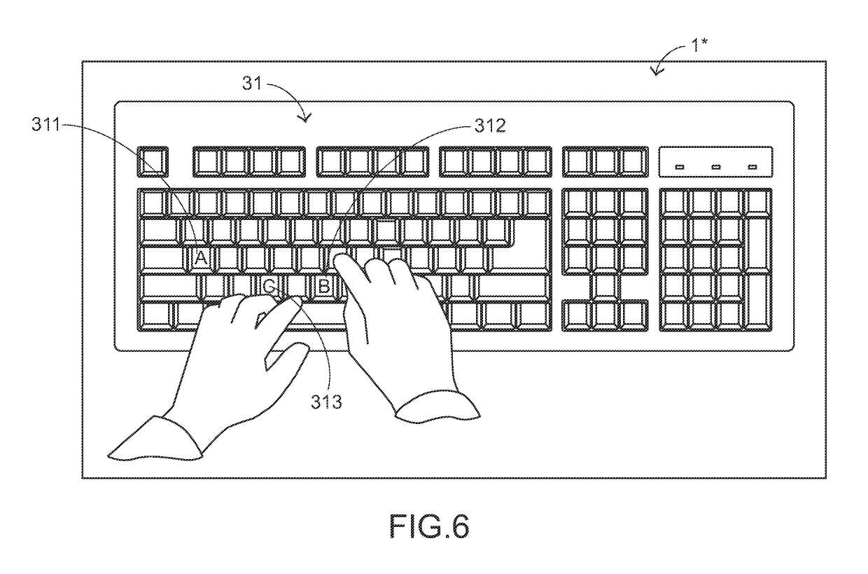

FIG. 5 is a schematic architecture diagram illustrating an input device model testing system according to a third embodiment of the present invention. As shown in FIG. 5, the input device model testing system 3 comprises a keyboard model 31, an image pickup device 32, a microphone 34, a computer screen 33 and a computer host 35. The keyboard model 31 comprises a plurality of key zones. For example, these key zones comprises an A key zone 311 (see FIG. 6), a B key zone 312 (see FIG. 6), a C key zone 313 (see FIG. 6), and so on. The image pickup device 32 is in communication with the computer host 35 for capturing the keyboard model 31, thereby generating a model image I* to the computer host 35. The model image I* also includes the image of the key zone that is depressed by the user. The microphone 34 is in communication with the computer host 35 for receiving a depressing sound emitted from the keyboard model 31 when the keyboard model 31 is depressed by the user. When the clicking sound is received, the microphone 34 issues a depressing signal SC* to the computer host 35. The computer screen 33 is in communication with the computer host 35 for displaying an input message interface W*. The depressing signal SC* and the model image I* are transmitted to the computer host 35. The computer host 35 further comprises a model image analyzing program 351 and the input message interface W*. According to the model image I*, the model image analyzing program 351 discriminates which of key zones is depressed. In this embodiment, the input message interface W* is a Microsoft Word document file. Alternatively, the input message interface W* is a Notepad file.

FIG. 6 is schematic diagram illustrating a model image obtained by the input device model testing system according to the third embodiment of the present invention. Please refer to FIGS. 5 and 6. When the input device model testing system 2 is used by the user U* to test the keyboard model 31, the input message interface W* is opened and displayed on the computer screen 33. Under this circumstance, instead of looking at the keyboard model 31, the line of vision V* of the user U* is directed toward the computer screen 33. The A key zone 311, the B key zone 312 and the C key zone 313 of the keyboard model 31 are successively depressed by the user U*, the images of the actions of depressing the A key zone 311, the B key zone 312 and the C key zone 313 by the user U* will be recorded in the model image I*. The model image I* is then transmitted to the computer host 35 to be analyzed by the model image analyzing program 351. In addition, the depressing sounds emitted from the keyboard model 31 when the A key zone 311, the B key zone 312 and the C key zone 313 are depressed by the user U* will be recorded by the microphone 34, so that the microphone 34 issues corresponding depressing signals SC* to the computer host 35. According to the depressing signals SC*, the computer host 35 could confirm whether these key zones are actually depressed.

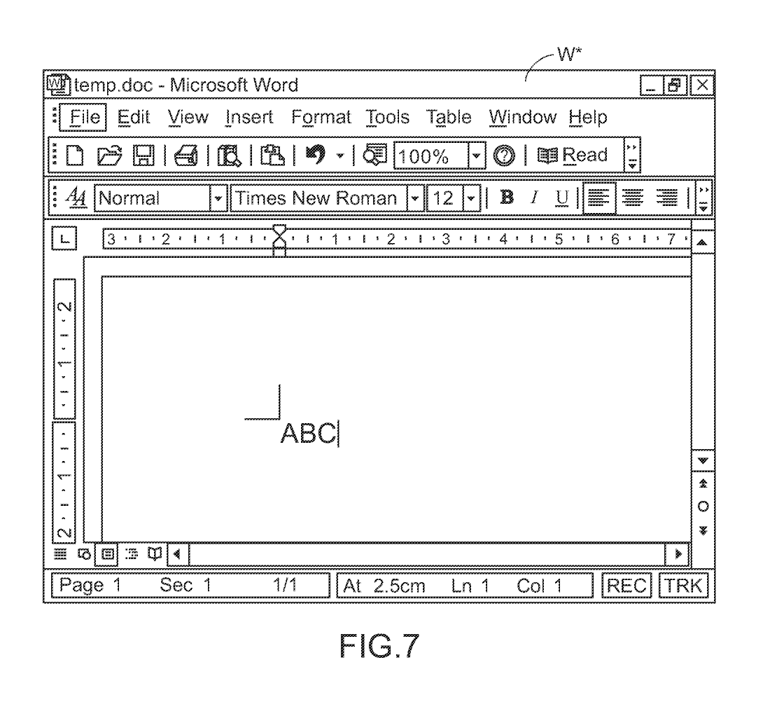

Please refer to FIG. 6 again. By the model image analyzing program 351, the model image I* is divided into a plurality of image blocks corresponding to respective key zones. In a case that the finger of the user U* is typing a letter and the image block corresponding to a depressed key zone is sheltered by the finger of the user U*, the model image analyzing program 351 could realize which key zone is depressed by the user U* by analyzing the model image I*. According to the depressing signal SC* issued from the microphone 34, the computer host 35 could realize that a key zone is depressed. After the computer host 35 discriminate that the A key zone 311, the B key zone 312 and the C key zone 313 are actually depressed, the letters ABC are inputted to the input message interface W* and also shown on the computer screen 33 by the computer host 35 (see FIG. 7).

From the above description, the input device model testing system of the present invention allows the user to be personally on the scene to simulate the mouse model as the real mouse. During the testing procedure of the input device model testing system, the computer host could execute instructions in response to operations of the mouse model or the keyboard model. Since the procedure of testing the input device model is substantially the same as the practical condition of operating the input device, the defects associated with the usage of the input device model could be easily found in order to be corrected by the manufacture.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input device model testing system, comprising:
a working plane comprising a plurality of simulated icons;
a mouse model placed on said working plane for pointing to one of said simulated icons, wherein said mouse model comprises a cursor element, a first button zone and a second button zone;
a first image pickup device for capturing said working plane, thereby generating a working plane image, wherein said working plane image includes an image of said simulated icon that is pointed by said cursor element of said mouse model;
a second image pickup device for capturing said mouse model, thereby generating a model image, wherein said model image includes an image of said button zone that is clicked;
a first computer screen for displaying said working plane image;
a microphone for receiving a clicking sound emitted from said mouse model when said mouse model is clicked, thereby generating a clicking signal; and
a computer host in communication with said first image pickup device, said second image pickup device, said microphone and said first computer screen for receiving said clicking signal, said working plane image and said model image, wherein said computer host comprises:
a model image analyzing program for discriminating which of said button zones is clicked according to said model image;
a working plane image analyzing program for discriminating which of said simulated icons is pointed by said cursor element according to said working plane image;
a simulated icon link program for establishing linkages between said simulated icons and respective icon shortcuts; and
a plurality of icon shortcuts corresponding to respective simulated icons,
wherein said computer host discriminates which of said button zones is clicked and which of said simulated icons is pointed according to said clicking signal and by said model image analyzing program and said working plane image analyzing program, so that a first button function or a second function associated with said pointed simulated icon is executed, and a result of executing said first button function or said second function is displayed on said first computer screen.

2. The input device model testing system according to claim 1 wherein after said computer host discriminates which of said button zones is clicked and which of said simulated icons is pointed, said simulated icon link program executes a function of linking said pointed simulated icon with a corresponding icon shortcut.

3. The input device model testing system according to claim 2 wherein said icon shortcuts comprise a “My Computer” icon shortcut, a “My Document” icon shortcut, and an “Internet Explorer” icon shortcut.

4. The input device model testing system according to claim 3 wherein said first button function and the second button function are a left-button function and a right-button function, respectively.

5. The input device model testing system according to claim 4 wherein when said cursor element is pointed to said simulated icon corresponding to said “My Computer” icon shortcut and said first button zone of said mouse model is clicked, said simulated icon link program executes a function of triggering said “My Computer” icon shortcut.

6. The input device model testing system according to claim 4 wherein when said cursor element is pointed to said simulated icon corresponding to said “My Computer” icon shortcut and said second button zone of said mouse model is clicked, said simulated icon link program executes a function of showing a right-button menu.

7. The input device model testing system according to claim 4 wherein when said cursor element is pointed to said simulated icon corresponding to said “My Computer” icon shortcut and said first button zone of said mouse model is double clicked, said simulated icon link program executes a function of opening said “My Computer” icon shortcut.

8. The input device model testing system according to claim 1 wherein said working plane is a cardboard, and said simulated icons are drawn on said cardboard.

9. The input device model testing system according to claim 1 wherein said working plane is a glass platform, said input device model testing system further comprises a second computer screen under said glass platform and in communication with said computer host for displaying a Windows interface of said computer host, and said icon shortcuts are shown on said Windows interface.

10. The input device model testing system according to claim 9 wherein said simulated icons shown on said glass platform correspond to said icon shortcuts shown on said Windows interface, respectively.

11. The input device model testing system according to claim 1 wherein said cursor element comprises:
an arrow part for pointing to one of said simulated icons; and
an extension part connected to a main body of said mouse model.

12. The input device model testing system according to claim 11 wherein said cursor element is made of transparent plastic material, and said arrow part of said cursor element is coated with white paint for facilitating identification.

13. The input device model testing system according to claim 1 wherein said model image analyzing program and the working plane image analyzing program respectively discriminate said clicked button zone and said pointed simulated icon according to an image recognition technology.

14. An input device model testing system, comprising:
a keyboard model comprising a plurality of key zones;
an image pickup device for capturing said keyboard model, thereby generating a model image, wherein said model image includes an image of said key zone that is depressed;
a computer screen for displaying an input message interface;
a microphone for receiving a depressing sound emitted from said keyboard model when one of said key zones of said keyboard model is depressed, thereby generating a corresponding depressing signal; and
a computer host in communication with said image pickup device, said microphone and said computer screen for receiving said depressing signal and said model image, wherein said computer host comprises:
a model image analyzing program for discriminating which of said key zones is depressed according to said model image; and
said input message interface,
wherein said computer host discriminates which of said key zones is depressed according to said depressing signal and by said model image analyzing program, so that a text or symbol corresponding to said depressed key zone is inputted to said computer host and said text or symbol is shown on said input message interface of said computer screen.

15. The input device model testing system according to claim 14 wherein said input message interface is a Microsoft Word document file or a Notepad file.

16. The input device model testing system according to claim 14 wherein said model image is divided into a plurality of image blocks by said model image analyzing program, and said image blocks correspond to respective key zones.

17. The input device model testing system according to claim 16 wherein said key zones at least comprises an A key zone, a B key zone, and a C key zone.

18. The input device model testing system according to claim 17 wherein when said A key zone, said B key zone and said C key zone are successively depressed and respective depressing signals are generated by said microphone, said image blocks of said model image corresponding to said A key zone, said B key zone and said C key zone are successively sheltered and said depressing signals are transmitted to said computer host, so that letters ABC are inputted to said input message interface and shown on said computer screen by said computer host.

19. The input device model testing system according to claim 14 wherein said model image analyzing program discriminates said depressed zone according to an image recognition technology.
